(19) United States
(12) Patent Application Publication
(10) Pub. No.: US 2004/0030663 A1
(43) Pub. Date: Feb. 12, 2004

(54) Method and assembly for the computer-assisted mapping of a plurality of temporarly variable status descriptions and method for training such an assembly

(76) Inventors: Caglayan Erdem, Munchen (DE); Achim Muller, Munchen (DE); Ralf Neuneier, Munchen (DE); Hans-Georg Zimmermann, Starnberg (DE)

Correspondence Address: STAAS & HALSEY LLP, SUITE 700, 1201 NEW YORK AVENUE, N.W., WASHINGTON, DC, 20005, US

(21) Appl. No.: 10/381,818

(22) PCT Filed: Sep. 28, 2001
(86) PCT No.: PCT/DE01/03731

(51) Int. Cl. G06F 15/18; G06F 15/00; G10L 11/00

(52) U.S. Cl. 706/14; 706/12; 704/200

(57) ABSTRACT

The invention relates to the computer-assisted mapping of a plurality of temporarily variable status conditions. According to the invention, a first status description in a first state space is mapped onto a second status description in the second state space by mapping, and the second status description of a temporarily later state is taken into consideration during mapping. By carrying out a further mapping, the second state description is mapped back onto a third state description in the first state space.

The invention relates to a method and an assembly for computer-assisted mapping of a plurality of temporarily variable status descriptions as well as a method for training an assembly for computer-assisted mapping of a plurality of temporarily variable status descriptions.

It is known from [1]—that an assembly for mapping a plurality of temporary variable status descriptions is to be used to describe a dynamic process. This assembly is implemented using interlinked processing elements under which the mapping is executed.

In general a dynamic process is usually described by a status transition description which is not visible for an observer of the dynamic process and an output equation that describes observable values of the technical dynamic process.

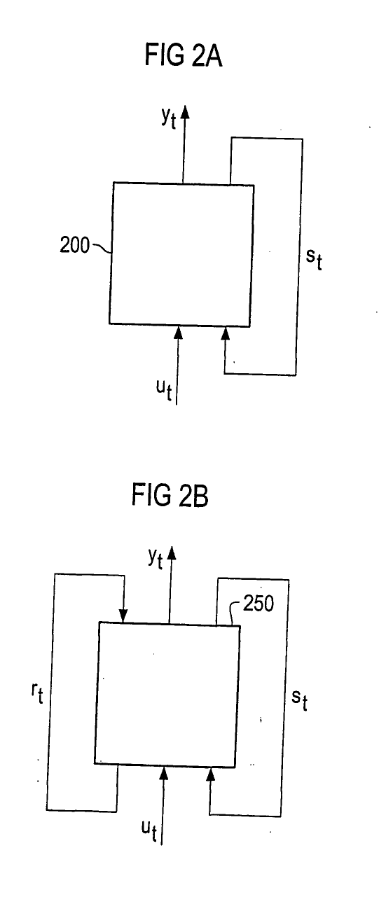

Such a structure is shown in FIG. 2a.

A dynamic system 200 is subject to the influence of an external input variable u of a specifiable dimension, in which case an input value uₜ is identified by uₜ at a time t:

uₜ ε [symbol] ¹,

whereby a natural number is designated by 1.

The input variable uₜ at a time t causes a change of the dynamic process that is running in dynamic system 200.

An internal status sₜ (sₜ ε [symbol] ^{m}) of the specifiable dimension m at a time t is not observable for the observer of the dynamic system.

Depending on the inner state sₜ and the input variable uₜ a state transition of the internal state sₜ of the dynamic process is brought about and the state of the dynamic process undergoes a transition into a follow-up state sₜ₊₁ at a follow-up time of t+1.

In this case the following applies:

sₜ₊₁=f(sₜ,uₜ) (1)

whereby a general mapping rule is designated by f(.).

An output variable yₜ that can be observed by the observer of the dynamic system 200 at a time t depends on the input variable uₜ as well as the internal status sₜ.

The dependence of the output variable yₜ on the input variable uₜ and the internal state sₜ of the dynamic process is given by the following general specification:

yₜ=g(sₜ,uₜ), (2)

where a general mapping rule is designated with g(.).

To describe dynamic system 200 an assembly of connected processing elements in the form of a neural network of interconnected neurons is used in [1]. The connections between the neurons of the neural network are weighted.

The weights of the neural network are summarized in a parameter vector v.

Thus an internal status of a dynamic system which is subject to a dynamic process depends, according to the following specification, on the input variable uₜ and the internal status of the preceding time sₜ and the parameter vector v:

sₜ+1=NN(v, sₜ, uₜ)

where NN(.) designates a mapping rule specified by the neural network.

The assembly known from [1] and designated as Time Delay Recurrent Neural Network (TDRNN) is trained in such a way in the training phase that for an input variable uₜ a target variable yₜ^{d} is determined at a real dynamic system in each case. The tuple (input variable, target variable determined) is designates as a training datum. A large number of such training data form a training data record.

In this case consecutive tuples (uₜ₋₄, yₜ₋₄^{d}) (uₜ₋₃, yₜ₋₃^{d}), (uₜ₋₂, yₜ₋₂^{d}) of times (t−4, t−3, t−3, . . . ) of the training data record each represent a specified step in time.

The TDRNN is trained with the training data record. An overview of different training methods is also to be found in [1].

It is to be stressed at this point that only output variable yₜ is detectable at time t of dynamic system 200. The “internal” system state sₜ is not observable.

In the training phase the following cost function E is usually minimized:

$$E = \frac{1}{T} {\sum }_{t = 1}^{T} {( {y}_{t} - {y}_{t}^{d} )}^{2} {\to }_{f , g}^{min ,}$$

where T designates a number of times taken into consideration.

In addition an overview of the fundamentals of neural networks and the possible applications of neural networks in the area of the economy can be found in [2].

The disadvantage of the known assemblies and methods is that a dynamic process to be described by them can only be described with insufficient accuracy. This is attributable to the fact that with the mappings used with these assemblies and methods the status transition description of the dynamic process cannot be mapped sufficiently accurately.

Thus the underlying problem for the invention is to find a method and an assembly as well as a method for training an assembly for computer-assisted mapping of a plurality of temporarily variable status descriptions with which a status transition description of a dynamic system can be described with improved accuracy and for which the assembly and methods are not subject to the disadvantages of the known assemblies and methods.

The problems are resolved by an assembly as well as methods with the features in accordance with the relevant independent patent claim.

The method for computer-assisted mapping of a plurality of temporarily variable status descriptions that each describe a temporarily variable state of a dynamic system at a corresponding point in time in a state area, which dynamic system maps an input variable to an associated output variable consists of the following steps:

a) a first mapping maps a first status description in a first state space onto a second status description in a second state space,

b) the first mapping takes into consideration the second status description of a temporarily earlier state,

c) a second mapping maps the second status description onto a third status description in the first state space, identified by the fact that

d) the first status description is mapped by a third mapping onto a fourth status description in the second state space,

e) the third mapping takes into consideration the fourth status description of a temporarily later state and

f) the fourth status description is mapped by a fourth mapping onto the third status description, whereby the mappings are adapted in such a way that the mappings of the first status description onto the third status description describe with a specified level of accuracy the mapping of the input variable to the associated output variable.

The assembly for computer-assisted mapping of a plurality of temporarily variable status descriptions, each of which describes a temporarily variable state of a dynamic system at a corresponding point in time in a state space, which dynamic system maps an input variable to an associated output variable, has the following components:

a) with a first mapping unit that is created in such a way that a first status description in a first state space is mappable by a first mapping to a second status description in a second state space,

b) and the first mapping unit is created in such a way that with the first mapping the second status description of a temporarily earlier state can be taken into consideration,

c) with a second mapping unit that is created in such a way that the second status description is mappable by a second mapping to a third status description in the first state space, identified by the fact that

d) the assembly features a third mapping unit that is created in such a way that the first status description is mapped by a third mapping to a fourth status description in the second state space,

e) and the third mapping unit is created in such a way that with the third mapping the fourth status description of a temporarily later state can be taken into consideration,

f) and the assembly features a fourth mapping unit that is created in such a way that the fourth status description can be mapped by a fourth mapping onto a third status description,

whereby the mapping units are created in such as way that the mappings of the first status description onto the third status description describe the mapping of the input variable to the associated output variable with a specified level of accuracy.

The method for training an assembly for computer-assisted mapping of a plurality of temporarily variable status descriptions that each describe a temporarily variable state of a dynamic system at a corresponding point in time in a state space, which dynamic system maps an input variable to a corresponding output variable, which assembly features the following components:

a) with a first mapping unit that is created in such a way that a first status description in a first state space is mappable by a first mapping onto a second status description in a second state space,

b) and the first mapping unit is created in such a way that with the first mapping the second status description of a temporarily earlier state can be taken into consideration,

c) with a second mapping unit that is created in such a way that the second status description is mappable by a second mapping onto a third status description in the first state space,

d) with a third mapping unit that is created in such a way that the first status description is mappable by a third mapping onto a fourth status description in the second state space,

e) and the third mapping unit is created in such a way that with the third mapping the fourth status description of a temporarily later state can be taken into account,

f) with a fourth mapping unit that is created in such a way that the fourth status description is mappable by a fourth mapping onto the third status description,

features the following training steps:

with the training, by using at least one prespecified training data pair which is formed from the input variable and the associated output variable, the mapping units are created in such a way that the mapping of the first status description to the third status description describes with a sufficient level of accuracy the mappings of the input variable to the associated output variable.

The assembly is particularly suited to performing the methods set out in the invention or to one of the developments listed below.

Preferred developments of the invention are produced by the dependent claims.

The development described below relate both to the methods and to the assembly.

The invention and the development described below can be implemented both in software and also in hardware, for example by using a specific electrical circuit.

Furthermore an implementation of the invention or of a development described below is possible though a machine-readable storage medium on which a computer program is stored which executes the invention or development.

The invention or any development described below can also be implemented by a computer program product that features a storage medium on which a computer program that executes the invention or development is stored.

In an embodiment a mapping unit is implemented by a neural layer consisting of at least one neuron. An improved mapping of a dynamic system as regards accuracy can be achieved however by using a number of neurons in a neuron layer.

In a development a status description is a vector of specifiable dimension.

The preferred choice is a development to determine a dynamic of a dynamic process.

An embodiment features a measuring assembly for recording physical signals with which the dynamic process is described.

The preferred choice is a development to determine a dynamic of a dynamic process that runs in a technical system, in particular in a chemical reactor or to determine the dynamics of an electrocardiogram or to determine an economic or macro economic dynamic,

A development can also be used to monitor or control a dynamic process, in particular a chemical process.

The status descriptions can be determined from physical signals.

A development is used for speech processing whereby the input variable is a first item of speech information of a word to be spoken and/or a syllable to be spoken and the output variable is a second item of speech information of the word to be spoken and/or the syllable to be spoken.

In a further embodiment the first item of speech information comprises a classification of the word to be spoken and/or the syllable to be spoken and/or an item of break information of the word to be spoken and/or the syllable to be spoken. The second item of speech information comprises an item of accentuation information of the word to be spoken and/or the syllable to be spoken.

An implementation in the area of speech processing is also possible with which the first item of speech information is an item of phonetic and/or structural information of the word to be spoken and/or the syllable to be spoken. The second item of speech information includes frequency information of the word to be spoken and/or the syllable to be spoken. Exemplary embodiments of the invention are shown in Figures and are explained below.

The examples in the Figures are as follows

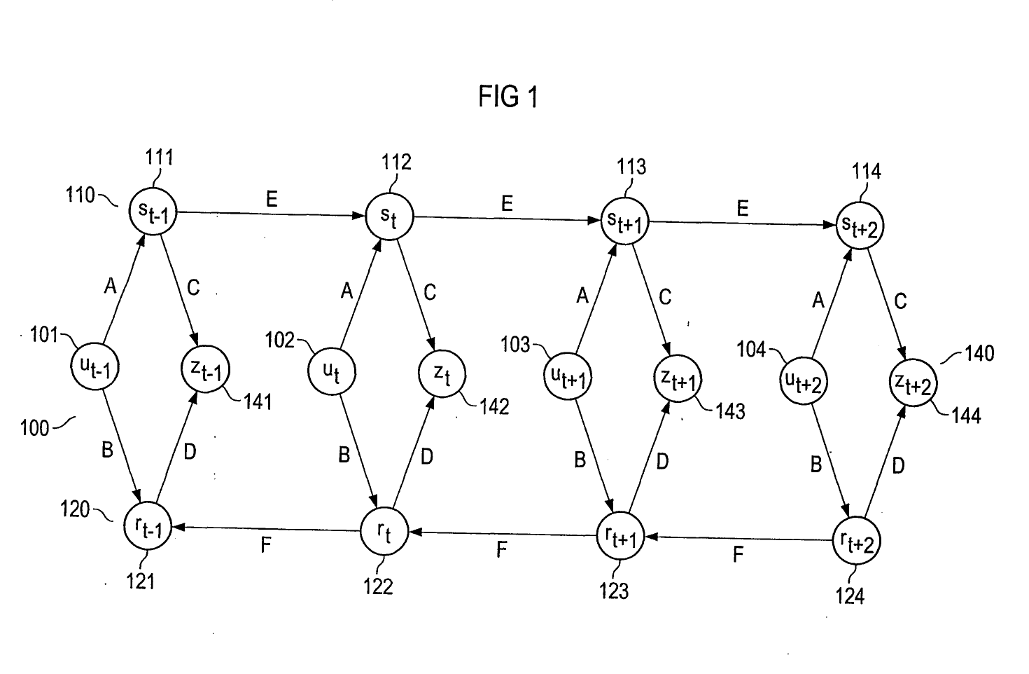

FIG. 1 Sketch of an assembly in accordance with the first exemplary embodiment (KRKNN);

FIGS. 2a and 2b A first sketch of a general description of a dynamic system and a second sketch of a description of a dynamic system, which is based on a “causal-retro-causal” relationship;

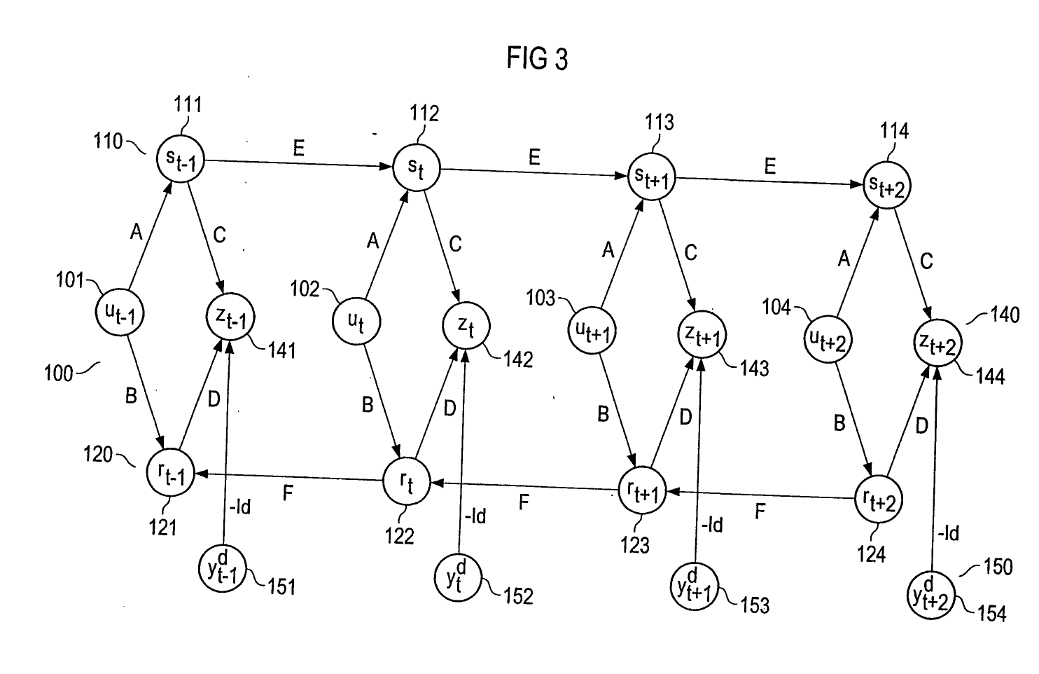

FIG. 3 a assembly in accordance with a second exemplary embodiment (KRKFKNN);

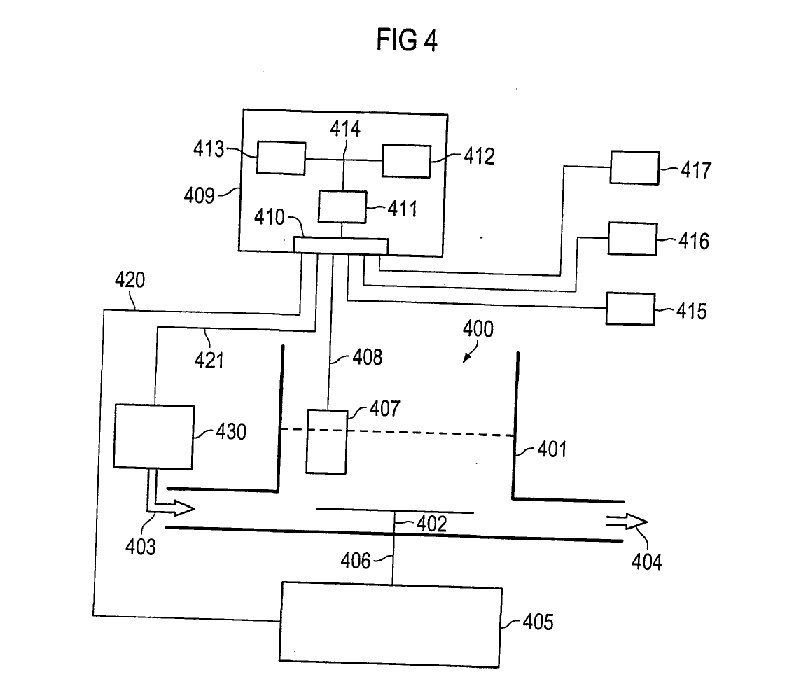

FIG. 4 A sketch of a chemical reactor from which variables are measured which are then processed with the assembly in accordance with the first exemplary embodiment;

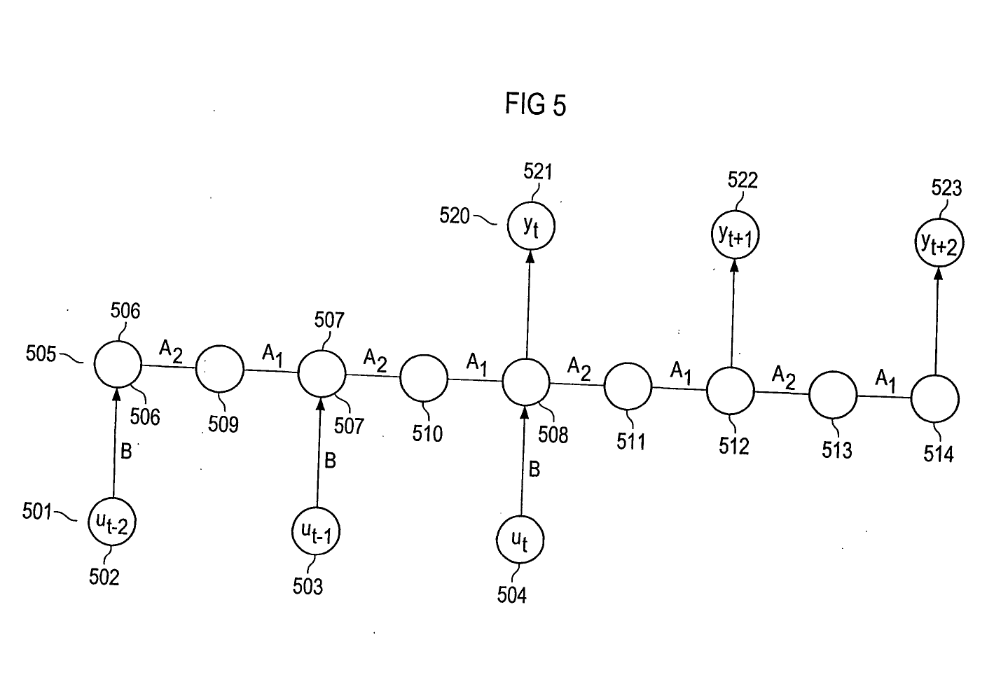

FIG. 5 A sketch of an assembly of a TDRNN which is developed with an infinite number of states over time;

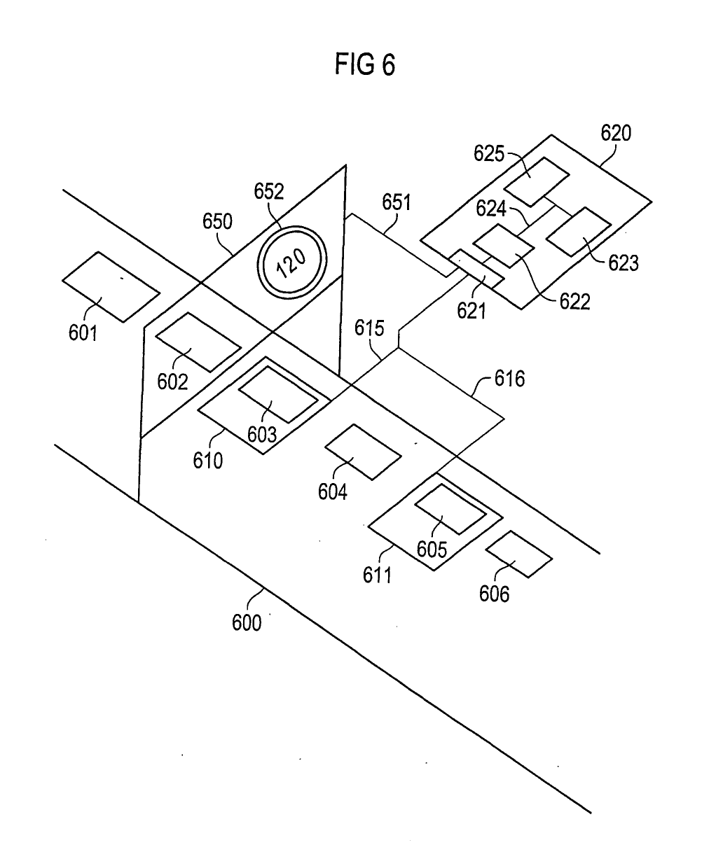

FIG. 6 A sketch of a traffic control system which is modeled with the assembly within the framework of a second exemplary embodiment;

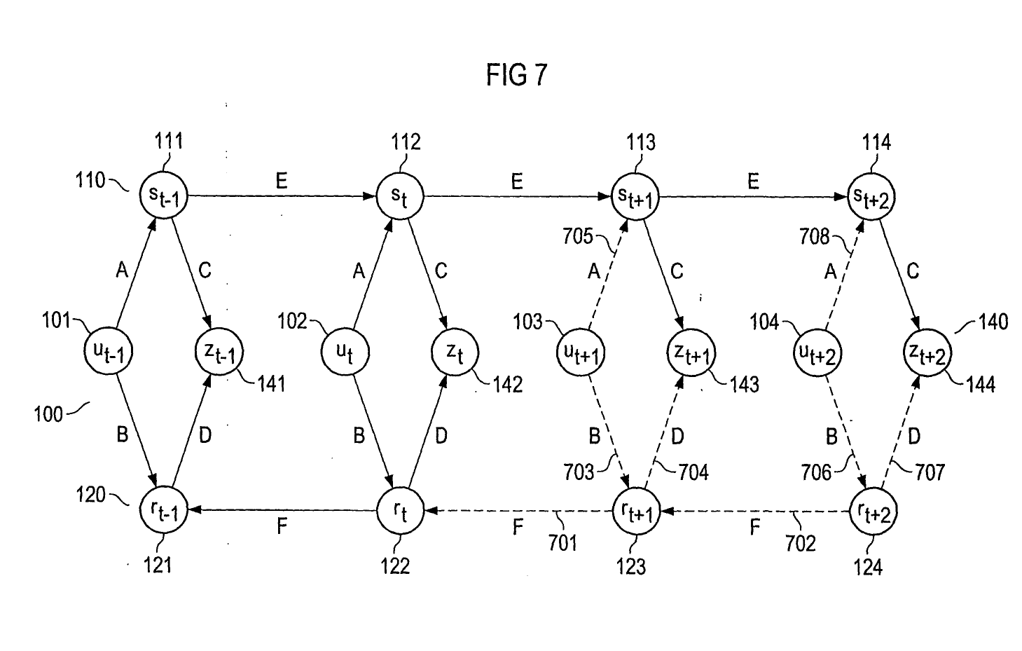

FIG. 7 Sketch of an alternative assembly in accordance with a first exemplary embodiment (KRKNN with released connections);

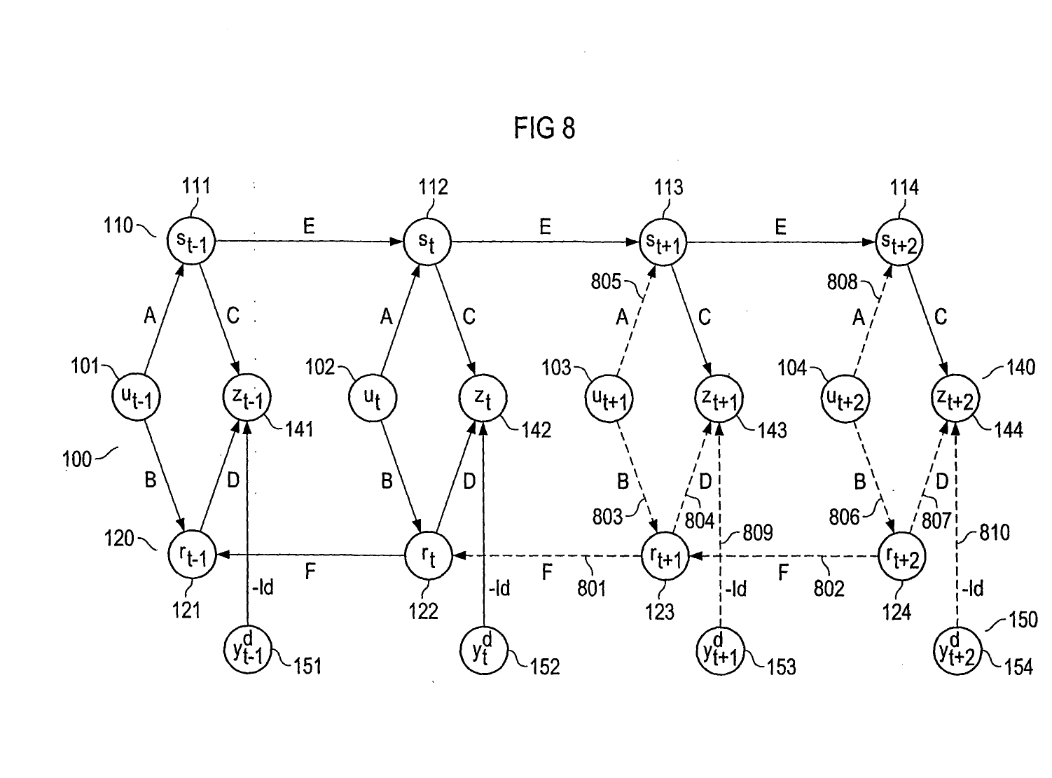

FIG. 8 Sketch of an alternative assembly in accordance with a second exemplary embodiment (KRKFKNN with released connections);

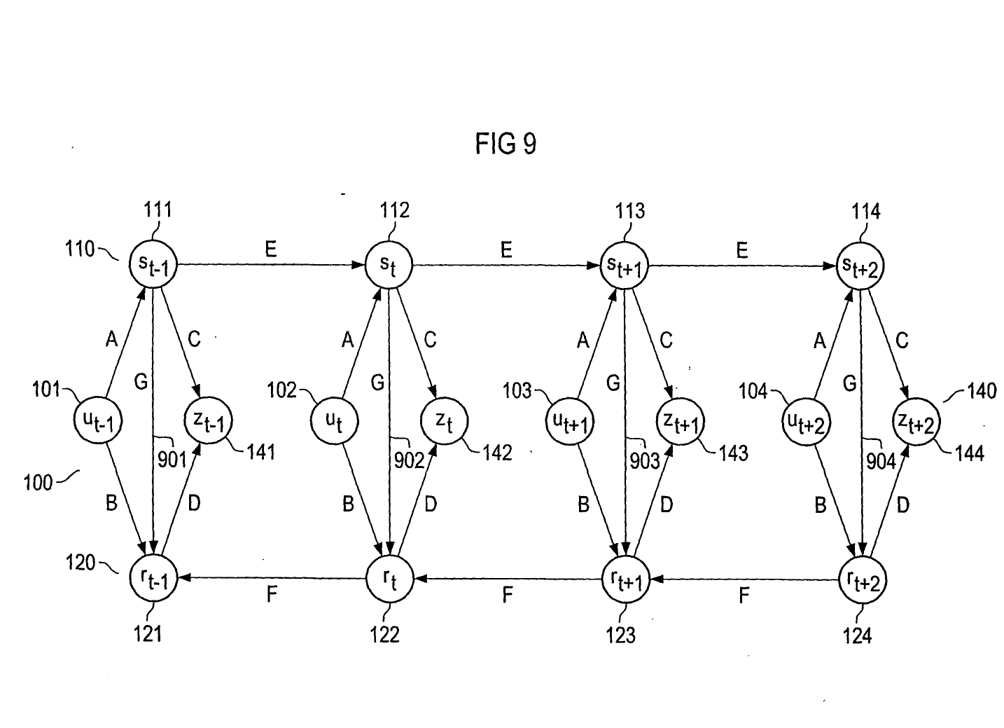

FIG. 9 Sketch of an alternative assembly in accordance with a first exemplary embodiment (KRKNN);

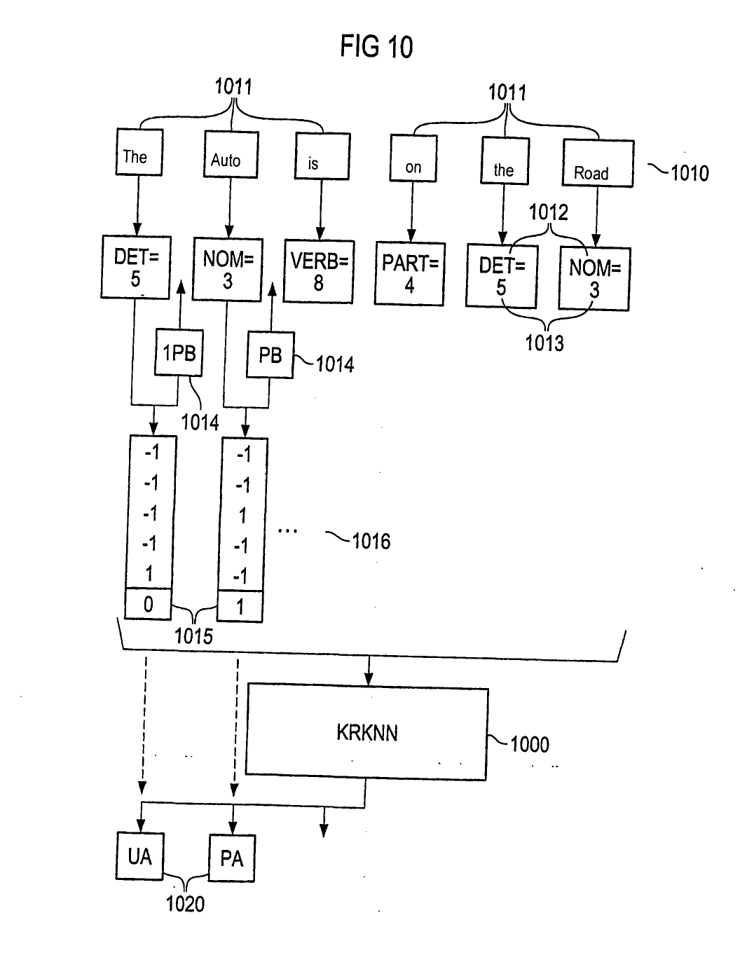

FIG. 10 Sketch of speech processing using an assembly in accordance with a first exemplary embodiment (KRKNN);

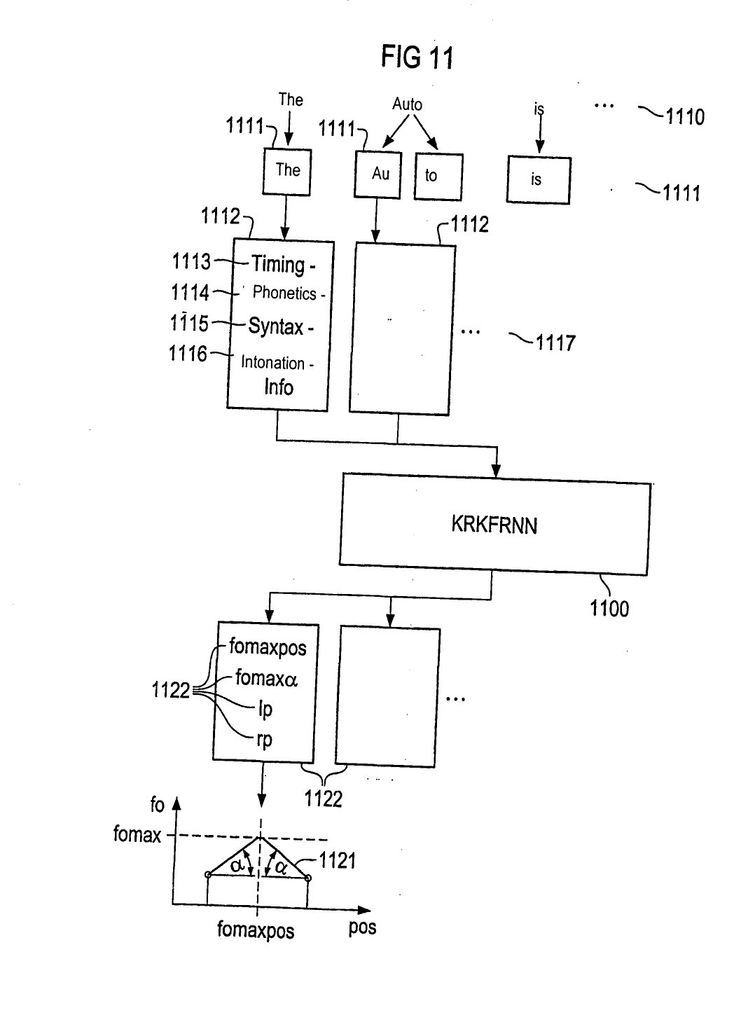

FIG. 11 Sketch speech processing using an assembly in accordance with a second exemplary embodiment (KRKFKNN).

First exemplary embodiment: Chemical reactor

FIG. 4 shows a chemical reactor 400 that is filled with a chemical substance 401. The chemical reactor 400 includes an agitator 402 with which the chemical substance 401 is agitated. Further chemical substances 403 flowing into the chemical reactor 400 react during a specifiable period in the chemical reactor 400 with the chemical substance 401 already contained in the chemical reactor 400. A substance 404 flowing out of the reactor 400 is routed out of the chemical reactor 400 via an output.

Agitator 402 is connected via a line with a control unit 405 with which an agitation frequency of agitator 402 can be set via a control signal 406.

Furthermore a measuring device 407 is provided with which the concentrations of the chemicals contained in chemical substance 401 are measured.

Measurement signals 408 are routed to a computer 409, digitized in computer 409 via an input/output interface 410 and an analog/digital converter 411 and stored in a memory 412. A processor 413 is, like the memory 412, connected via a bus 414 with the analog/digital converter 411. The computer 409 is furthermore connected via an input/output interface 410 with control unit 405 of the agitator 402 and thus computer 409 controls the frequency of agitator 402.

The computer 409 is furthermore connected via an input/output interface 410 with a keyboard 415, a mouse 416 and a screen 417.

The chemical reactor 400 as a dynamic technical system 250 is thus subject to a dynamic process.

The chemical reactor 400 is described by means of a status description. An input variable uₜ of this status description is made up in this case of a specification of the temperature obtaining in the chemical reactor 400 as well as the pressure obtaining in the chemical reactor 400 and the agitation frequency set at point in time t. This means that the input variable uₜ is a three-dimensional vector.

The object of the modeling of chemical reactor 400 described below is to determine the dynamic development of the concentration of substances in order to allow efficient production of a specifiable target substance to be produced as outflowing substance 404.

This is done using the assembly described below and shown in FIG. 1.

The dynamic process underlying the described reactor 400 and features a so-called “causal-retro causal” relationship is described by a state transition description that is not visible to the observer of the dynamic process and an output equation that describes the variables of the technical dynamic process.

A structure of this type of dynamic systems with a “causal-retro-causal” relationship is shown in FIG. 2b.

The dynamic system 250 is subject to the influence of an external input variable u of specifiable dimension in which case an input variable uₜ at a point t is designated as uₜ:

uₜ ε [symbol] ¹, where 1 designates a natural number.

input variable uₜ at a point in time t causes a change in the dynamic process running in dynamic system 250.

An internal state of system 250 at a time t as to which internal state is not observable for an observer comprises in this case a first internal substatus sₜ and a second internal substrate rₜ.

Depending on the first internal substatus sₜ₋₁ at an earlier time t−1 and the input variable uₜ a status transition of the first internal substatus sₜ₋₁ of the dynamic process into a follow-on status sₜ is brought about.

In this case the following applies:

sₜ=f1(sₜ₋₁,uₜ) (5)

where f1(.) designates a general mapping rule.

In descriptive terms the first internal substatus sₜ is influenced by an earlier internal substatus sₜ₋₁ and input variable uₜ. This type of relationship is usually called “causality”.

Depending on the second internal substatus rₜ₊₁ at a subsequent time t+1 and the input variable uₜ, a status transition of the first internal status rₜ₊₁ of the dynamic process into a follow-up status rₜ is caused.

In this case the following applies:

rₜ=f2(rₜ₋₁, uₜ) (6)

where f2(.) designates a general mapping rule.

In pictorial terms the second internal substatus rₜ is influenced in this case by a later second internal substatus rₜ₊₁, in general therefore there is an expectation of a later status of dynamic system 250, and the input variable uₜ. This type of relationship is usually called “retro-causality”.

An output variable yₜ that can be observed by an observer of dynamic system 250 at a time t depends on both input variable uₜ, the first internal substatus sₜ and also the second internal substatus rₜ.

Output variable yₜ (yₜ ε [symbol] ⁿ) is specifiable dimension n.

The dependence of output variable yₜ on input variable uₜ, the first internal substatus sₜ as well as the second internal substatus rₜ of the dynamic process is given by the following general rule:

Yₜ=g(sₜ,rₜ) (7)

where g1(.) designates a general mapping rule.

To describe dynamic system 250 as well as its states an assembly of interconnected processing elements in the form of a neural network of interconnected neurons is used. This is shown in FIG. 1 and is referred to as a “Causal-retro-causal” neural network (KRKNN).

The connections between the neurons of the neural network are weighted. The weights of the neural network are summarized in a parameter vector v.

With this neural network the first internal substatus sₜ and the second internal substatus rₜ depends, as per the rules listed below, on input variable uₜ, the first internal substatus sₜ₋₁, the second internal substatus rₜ₊₁ as well as the parameter vectors vₛ, vₜ, v_{y}:

sₜ=NN(vₛ,sₜ₋₁,uₜ), (8)

rₜ=NN(vᵣ,rₜ₊₁,uₜ) (9)

Yₜ=NN(v_{y},sₜ,rₜ) (10)

where NN(.) designates a mapping rule specified by the neural network.

The KRKNN 100 as per FIG. 1 is a neural network developed over four points in time, t−1, t, t+1 and t+2.

The fundamentals of a neural network developed over a finite number of points in time are described in [1].

To make it easier to understand the principles underlying the KRKNN, FIG. 5 shows the known TDRNN as a neural network 500 developed over a finite number of points in time.

The neural network 500 shown in FIG. 5 features an input layer 501 with three sub-input layers 502, 503 and 504, each of which contains a specifiable number of input processing elements, for which input variables uₜ can be set up at a specifiable point in time t, i.e. in further described time sequence values.

input processing elements, i.e. input neurons, are connected via variable connections to neurons of a specifiable number of hidden layers 505.

In this case neurons of a first hidden layer 506 are connected with neurons of the first sub-input layer 502. Furthermore neurons of a second layer 507 are connected to neurons of the second input layer 503. Neurons of a third hidden layer 508 are connected to neurons of the third sub-input layer 504.

The connections between the first sub-input layer 502 and the first hidden layer 506, the second sub-input layer 503 and the second hidden layer 507 as well as the third sub-input layer 504 and the third hidden layer 508 are the same in each case. The weights of all connections are contained in a first connection matrix B in each case.

Neurons of a fourth hidden layer 509 are connected with their inputs with the outputs of neurons of the first hidden layer 506 in accordance with a structure given by a second connection matrix A2. Furthermore outputs of the neurons of the fourth hidden layer 509 are connected with the inputs of neurons of the second hidden layer 507 in accordance with a structure given by a third connection matrix A1.

Furthermore neurons of a fifth hidden layer 510 are connected with their inputs in accordance with a structure given by the third connection matrix A2 with outputs of neurons of the second hidden layer 507. Outputs of the neurons of the fifth hidden layer 510 are connected with inputs of neurons of the third hidden layer 508 in accordance with a structure given by a third connection matrix A1.

This type of connection structure applies equivalently to the connection structure for a sixth hidden layer 511, which are connected in accordance with the structure given by the second connection matrix A2 with outputs of the neurons of the third hidden layer 508 and in accordance with the structure given by the third connection matrix A1 with neurons of a seventh hidden layer 512.

Neurons of an eighth hidden layer 513 are in their turn connected in accordance with a structure given by the first connection matrix A2 with neurons the seventh hidden layer 512 and via connections in accordance with the third connection matrix A1 with neurons of a ninth hidden layer 514. The specifications in the indices in the relevant layers are specified by times t, t−1, t−2, tell, t+2 respectively to which the signals that can be tapped or fed to the outputs of the relevant layer relate in each case (uₜ, uₜ₋₁, uₜ₋₂).

An output layer 520 features three sub-output layers, a first sub-output layer 521, a second sub-output layer 522 and also a third sub-output layer 523. Neurons of the first sub-output layer 521 are connected in accordance with a structure given by an output connection matrix C with neurons of the third hidden layer 508. Neurons of the second sub-output layer are also connected in accordance with a structure given by an output connection matrix C with neurons of the eighth hidden layer 512. Neurons of the third sub-output layer 523 are connected in accordance with the output connection matrix C with neurons of the ninth hidden layer 514. At the neurons of sub-output layers 521, 522 and 523 the output variables for a time t, t+1, t+2 can be tapped in each case (yₜ, Yₜ₊₁, yₜ₊₂)

Working on this principle of what are known as shared weights, i.e. the principle that equivalent connection matrices in a neural network feature the same values at a given time, the assembly shown in FIG. 1 is explained below.

The sketches described below are to be understood in each case so that each layer or each sublayer features a specified number of neurons, i.e. computing elements. Sublayers of a layer each represent a system status of the dynamic system described by the assembly. Sublayers of a hidden layer accordingly each represent an “internal” system state. The relevant connection matrixes are any dimension and each contain for the corresponding connections between the neurons of the relevant layers the weight values.

The connections are directed and are indicated in FIG. 1 by arrows. An arrow direction specifies a “direction of processing” in particular a mapping direction or a transformation direction.

The assembly shown in FIG. 1 features an input layer 100 with four sub-input layers 101, 102, 103 and 104, whereby time sequence values uₜ₋₁, uₜ, uₜ₊₁, uₜ₊₂ are directable to each sub-input layer 101, 102, 103, 104 at a point t−1, t, t+1 or t+2 respectively.

The sub-input layers 101, 102, 103, 104 of the input layer 100 are connected in each case via connection in accordance with a first connection matrix A with neurons of a first hidden layer 110 each with four sublayers 111, 112, 113 and 114 of the first hidden layer 110.

The sub-input layers 101, 102, 103, 104 of the input layer 100 are additionally each connected via connections in accordance with a second connection matrix B with neurons of a second hidden layer 120 each with four sublayers 121, 122, 123 and 124 of the second hidden layer 120.

The neurons of the first hidden layer 110 are each connected in accordance with a structure given by a third connection matrix C with neurons of an output layer 140, that in its turn features four sub-input layers 141, 142, 143 and 144.

The neurons of the second hidden layer 120 are also each connected in accordance with a structure given by a fourth connection matrix D with the neurons of the output layer 140.

In addition the sublayer 111 of the first hidden layer 110 is connected via a connection in accordance with a fifth connection matrix E with the neurons of the sublayer 112 of the first hidden layer 110.

All other sublayers 112, 113 and 114 of the first hidden layer 110 also feature corresponding connections.

This means that in pictorial terms sublayers 111, 112, 113 and 114 of the first hidden sublayer 110 are connected in accordance with their temporal sequence.

Sublayers 121, 122, 123 and 124 the second hidden layer 120 are already connected to each other in the opposite direction.

In this case sublayer 124 of the second hidden layer 120 is connected via a connection in accordance with a sixth connection matrix F with the neurons of the 123 of the second hidden layer 120.

All other sublayers 123, 122 and 121 of the second hidden layer 120 feature the corresponding connections.

From a visual standpoint all sublayers 121, 122, 123 and 124 of the second hidden sublayer 120 are connected to each other in this case opposite their temporal sequence, i.e. t+2, t+1, t and t−1.

In accordance with the connections described, an “internal system status sₜ, sₜ₊₁ or sₜ₊₂ of the sublayer 112, 113 or 114 of the first hidden layer are each mapped from the associated input status uₜ, uₜ₊₁ or uₜ₊₂ and the preceding “internal” system status sₜ₋₁, sₜ or sₜ₊₁.

Furthermore in accordance with the connections described an “internal” system status rₜ₋₁, rₜ or rₜ₊₁ of the sublayers 121, 122 or 123 of the second hidden layer 120 is mapped in each case from the associated input status uₜ₋₁, uₜ or uₜ₊₁ and the following “internal” system status rₜ rₜ₊₁ or rₜ₊₂

In the sub-output layers 141, 142, 143 and 144 of the output layer 140 a status is mapped in each case from the associated “internal” system status sₜ₋₁, sₜ, sₜ₊₁ or s₁ of a sublayer 111, 112, 113 or 114 of the first hidden layer 110 and from the associated “internal” system status rₜ₋₁, rₜ, rₜ₊₁ or rₜ₊₂ of a sublayer 121, 122, 123 or 124 of the second hidden layer 120.

At an output of the first sub-output layer 141 of the output layer 140 a signal that depends on the “internal” system states (sₜ, rₜ) can thus be tapped. The same applies to the sub-output layers 142, 143 and 144.

In the training phase of the KRKNN the following cost function E is minimized:

$$E = \frac{1}{T} {\sum }_{t = 1}^{T} {( {y}_{t} - {y}_{t}^{d} )}^{2} {\to }_{f , g}^{min ,} \qquad ( 11 )$$

whereby T identifies a number of points in time taken into consideration.

As a training method back propagation methods are used. The training data record is obtained from the chemical reactor 400 in the following way.

Measuring device 407 is used to measure concentrations for specified input variables and direct them to processor 409 where they are digitized and grouped in a memory as a sequence of time values xₜ together with the corresponding input variables that correspond to the measured values.

For the training the weight values of the relevant connection matrices are adapted. The adaptation is undertaken so that the KRKNN describes as precisely as possible the dynamic system that it is mapping, in this case the chemical reactor.

The assembly from FIG. 1 is trained by using the training data record and the cost function E.

The assembly from FIG. 1 trained in accordance with the training method described above is used for control and monitoring of the chemical reactor 400. For this purpose a predicted output variable yₜ₊₁ is determined from the input variable uₜ₋₁. this will subsequently be used as a control variable, if necessary after possible editing, directed to control medium and 405 to control agitator 402 and control unit 434 for flow control (cf. FIG. 4).

2nd Exemplary embodiment: Lease price forecast

FIG. 3 shows a development of the KRKNN shown in FIG. 1 and described within the framework of the above embodiments.

The developed KRKNN described in FIG. 3, known as a causal-retro-causal error correction neural network (KRKFKNN) is used for a lease price forecast.

Input variable uₜ is made up in this case of specifications about a lease price, a living space offer, an inflation rate and an unemployment rate, which will produce information relating to a living area to be investigated at the end of the year in each case(December values). This means that the input variables are a four-dimensional vector. A temporal sequence of the input variables that consists of a plurality of temporarily consecutive vectors times steps of one year in each case.

The aim of the modeling and of the lease price mapping described below is to forecast a future lease price.

The description of the dynamic process of lease price mapping is undertaken using the assembly described below and shown in FIG. 3.

Components from FIG. 1 not provided with the same at reference signs for the same embodiment.

In addition the KRKFKNN features a second input layer 150 with for sub-input layers 151, 152, 153 and 154, whereby each sub-input layer 151, 152, 153, 154 time sequence values yₜ₋₁^{d}, yₜ^{d}, yₜ₊₁^{d}, yₜ₊₂^{d} for a respective time t−1, t, t+1 or t+2 can be fed in. The time sequence values yₜ₋₁^{d}, yₜ^{d}, yₜ₊₁^{d}, yₜ₊₂^{d} are measured output values at the dynamic system here.

The sub-input layers 151, 152, 153, 154 of the input layer 150 are each connected via connections in accordance with a 7th connection make checks which is a negative identity matrix with neurons of the output layer 140.

This means that there is a different state in the sub-input layers 141, 142, 143 and 144 of the output layer in each case (yₜ₋₁-yₜ₋₁^{d}), (yₜ-yₜ^{d}), (yₜ₊₁-yₜ₊₁^{d}) and (yₜ₊₂-yₜ₊₂^{d}).

The method for training at the Assembly described above for corresponds to the method for training the assembly in accordance with the first exemplary embodiment.

3rd Exemplary embodiment: Traffic modeling and traffic congestion forecast

A third exemplary embodiment below describes traffic modeling and will be used for congestion forecasting.

With the third exemplary embodiment the assembly in accordance with the first exemplary embodiment is used (cf. FIG. 1).

However the third exemplary embodiment differs from the first exemplary embodiment as it does from the second exemplary embodiment in that in this case the variable t originally used as a time variable is used as a local variable t.

An original description of a state at time t thus describes for the third exemplary embodiment a state at a first location t. The same applies for a status description at a time t−1 or t+1 or t+2.

Furthermore the analog transfer of the time variability to a location variability results in locations t−1, t, t+1 and t+2 being arranged consecutively along the route in a specified direction of travel.

FIG. 6 shows a road 600 being traveled down by cars 601, 602, 603, 604, 605 and 606.

Integrated conductor loops 610, 611 in road 600 accept electrical signals in the known way and route the electrical signals 615, 616 to a computer 620 via an input/output interface 621. In an analog/digital converter 622 connected to the input/output interface the electrical signals are digitized in a time sequence and stored in a memory 623 that is connected via a bus 624 with the analog/digital converter 622 and a processor 625. Via the input/output interface 621 control signals 951 will be directed to a traffic management system 650, from which in a traffic management systems 650 a pre-specified speed limit 652 can be set to also further specifications of traffic regulations which are displayed via traffic management system 650 to drivers of vehicles 601, 602, 603, 604, 605 and 606. The following local state variables are used in this case for traffic modeling:

traffic flow speed v,

Vehicle density

$$p \frac{Veh}{km}$$

(p=number of vehicles per kilometer),

Traffic flow q (q=number of vehicles per hour

$$\frac{Veh}{h} ,$$

(q=v * p)), and

the speed limits 952 shown in each case at a particular time by traffic control system 950.

The local status variables are measured as described above using the conductor loops 610, 611.

Thus these variables (v(t), p(t), q(t)) represent a status of the technical systems “traffic” at a particular time t. from these variables and evaluation r(t) offer a current status in each case is undertaken, for example as regards traffic flow and, homogeneity. this evaluation can be quantitative or qualitative.

Within the framework of this exemplary embodiment the traffic dynamics are modeled in two phases:

From forecast variables determined in the application phase control signals 651 are formed and used to specify the speed limit to be selected for a future period (t+1).

Alternatives to the exemplary embodiments

The following paragraphs show a number of alternatives to the exemplary embodiments described above.

Alternative application areas:

The assembly described in the first exemplary embodiment can also be used to determine a dynamics of an electrocardiogram (ECG). This allows indicators which point to an increased risk of heart attack to be detected earlier. A sequence of ECG values measured on a patient are used as an input variable. In a further alternative to the first exemplary embodiment the assembly in accordance with the first exemplary embodiment will be used for traffic modeling in accordance with the third exemplary embodiment. As a further alternative to the first exemplary embodiment the assembly in accordance with the first exemplary embodiment will be used for traffic modeling in accordance with the third exemplary embodiment.

In this case the original variable t used (in the first exemplary embodiment) as a timing variable (with the first exemplary embodiment) as described within the framework of the third exemplary embodiment, is used as a local variable t.

The execution for this in the third exemplary embodiment applies correspondingly.

In a third alternative to the first exemplary embodiment the assembly in accordance with the first exemplary embodiment is used within the framework of speech processing (FIG. 10). The basic principles of this type of speech processing are known from [3]. In this case the assembly (KRKNN) 1000 is used to determine an accentuation in a sentence 1001 to be accentuated.

To do this the sentence 1010 to be accentuated is broken down into its words 1011 and these are classified in each case 1012 (part-of-speech tagging). The classifications 1012 are each coded 1013. Each code 1013 is expanded by phrase break Information 1014 that specifies in each case whether, when the sentence 1010 to be accentuated is spoken, a pause is made after the relevant word.

This type of coding of a sentence to be accentuated is known from [3] and [4].

From the expanded codes 1015 of the record a time sequence 1016 is formed in such as way that the temporal sequence of states corresponds to the order of the words in the sentence to be accentuated 1010. This time sequence 1016 is applied to the assembly 1000.

The assembly now determines for each word 1011 accentuation information 1020 (HA: main accent or strongly accentuated; NA: subsidiary accent or weakly accentuated; KA: No accent or not accentuated)that specifies whether the word concerned is spoken accentuated.

The execution for this in the first exemplary embodiment applies correspondingly.

The assembly described in the second exemplary embodiment can be used in an alternative for forecasting a macroeconomic dynamic such as for example the progress of an exchange rate or other key economic figures such as a stock market index for example. For this type of forecast an input variable is formed from time sequences of relevant macro economic or economic figures, such as interest rates, currencies or inflation rates.

In a further alternative for the second exemplary embodiment the assembly is used in accordance with the second exemplary embodiment as part of speech processing (FIG. 11). The basics of this type of speech processing are known from [5], [6], [7] and [8].

In this case, syllable-based speech processing, the assembly (KRKFKNN) 1100 is used to model a frequency sequence of a syllable of a word in a sentence.

This type of modeling is also known from [5], [6]), [7] and [8].

This involves breaking down the sentence to be modeled 1110 into syllables 1111. For each syllable a status vector 1112 is determined which describes the syllable phonetically and structurally.

This type of status vector 1112 comprises training information 1113, phonetic information 1114, syntax information 1115 and intonation information 1116.

This type of status vector 1112 is described in [4].

From the status vectors 1112 of the syllables 1111 of the sentence to be modeled 1110 a time sequence 1117 is formed in such a way that an order of states of time sequence 1117 corresponds to the sequence of the syllables 1111 in the sentence to be modeled 1110. This time sequence 1117 is applied to the assembly 1100.

The assembly 1100 now determines for each syllable 1111 a parameter vector 1122 with parameters 1120, fomaxpos, fomaxalpha, lp, rp that describe the frequency sequence 1121 of the relevant syllable 1111.

Such parameters 1120 as well as the description of a frequency sequence 1121 through these parameters 1120 are known from [5], [6], [7] and [8].

The execution for this in the second exemplary embodiment applies accordingly.

Structural alternatives

FIG. 7 shows a structural alternative for the assembly from FIG. 1 in accordance with the first exemplary embodiment. Components from FIG. 1 are shown for the same arrangement with the same reference characters in FIG. 7.

By contrast to the assembly shown in FIG. 1, with the alternative assembly in accordance with FIG. 7 the connections 701, 702, 703, 704, 705, 706, 707 and 708 are released or interrupted.

This alternative assembly, a KRKNN with released connections can be used both in a training phase and also in an application phase.

The training and also the application of the alternative assembly are executed in a similar way to that described in the first exemplary embodiment.

FIG. 8 shows a structural alternative to the assembly from FIG. 3 in accordance with the second exemplary embodiment. Components from FIG. 3 are shown for the same arrangement with the same reference characters in FIG. 8.

By contrast to the assembly shown in FIG. 3, with the alternative assembly in accordance with FIG. 8 the connections 801, 802, 803, 804, 805, 806, 807, 808, 809 and 810 are released or interrupted.

This alternative assembly, a KRKFKNN with released connections, can be used both in a training phase and also in an application phase.

The training and also the application of the alternative assembly are executed in a similar way to that described in the second exemplary embodiment.

It should be noted that it is possible only to used the KRKNN with released connections in the training phase and the KRKNN (without the released connections in accordance with the first exemplary embodiment) in the application phase.

It is also possible to use the KRKNN with released connections only in the application phase and the KRKNN (without the released connection in accordance with the first exemplary embodiment) in the training phase.

The same applies to the KRKFKNN and the KRKFKNN with released connections.

A further structural alternative for the assembly in accordance with the first exemplary embodiment is shown in FIG. 9.

The assembly in accordance with FIG. 9 is a KRKNN with a fixed point recurrence.

Components from FIG. 1 are shown for the same arrangement equipped with the same reference characters in FIG. 8.

By contrast to the assembly shown in FIG. 1, with the alternative assembly in accordance with FIG. 9 additional connections 901, 902, 903 and 904 are closed.

The additional connections 901, 902, 903 and 904 each feature a connection matrix GT with weights.

This alternative assembly can be used both in a training phase and also in an application phase. The training and also the application of the alternative assembly are executed in a similar way as described for the first exemplary embodiment.

Realization of a KRKNN by a SENN, Version 3.1 program code

There follows a possible realization of a KRKNN specified for program SENN, Version 3.1. The realization comprises a number of sections each containing program code required for processing in SENN, Version 3.1.

Possible realizations of the exemplary embodiments as well as the alternatives described can also be performed with program SENN, Version 3.1. (program code example—as in original Teil=Part)

The following publications are cited in this document: [1] S. Hayken, Neural Networks: A Comprehensive Foundation, Mc Millan College Publishing Company, Second Edition, ISBN 0-13-273350-1, S. 732-789, 1999.

[2] H. Rehkugler and H. G. Zimmermann, Neural Netze in der Ökonomie, Grundlagen and finanzwirtschaftliche Anwendungen (Neural Networks in the Economy, basics and Financial Applications), Verlag Franz Vahlen Munich, ISBN 3-8006-1871-0, S. 3-90, 1994;

[3] J. Hirschberg, Pitch accent in context: predicting intonational prominence from text, Artificial Intelligence 63, S. 305-340, Elsevier, 1993;

[4] IC. Ross et al., Prediction of abstract prosodic labels for Speech Synthesis, Computer Speech and Language, 10, S. 155-185, 1996;

[5] R. Haury et al., Optimisation of a Neural Network for Pitch Contour Generation, ICASSP, Seattle, 1998;

[6] C. Traber, FO generation with a database of natural FO patterns and with a neural network, G. Bailly and C. Benoit eds., Talking Machines: Theories, Models and Applications, Elsevier, 1992;

[7] E. Heuft et al., Parametric Description of FO-Contours in a Prosodic Database, Proc. ICPHS, Vol. 2, S. 378-381, 1995;

[8] C. Erdem, Topologieoptimierung eines Neural Netzes zur Generierung von FO-Verlaeufen durch Integration unterschiedlicher Codierungen, (Topology Optimization of FO sequences by Integration of different Coding) Tagungsband ESSV, Cottbus, 2000.

1. methods for computer-assisted mapping of a plurality of temporarily variable status descriptions that each describe a temporarily variable state of a dynamic system at an associated point in time which dynamic system maps an input variable to an associated output variable, with the following steps
a) a first status description in a first state space is mapped onto a second status description in a second state space,
b) with the first mapping the second status description a temporarily earlier state is taken into consideration,
c) a second mapping maps the second status description onto a third status description in the first state space, identified by the fact that
d) the first status description is mapped by a third mapping onto a fourth status description in the second state space,
e) with the third mapping the fourth status description of a temporarily later state is taken into consideration and
f) the fourth status description is mapped by a fourth mapping onto the third status description, whereby the mappings are adapted in such a way that the mappings of the first status description onto the third status description describes the mapping of the input variable onto the associated output variable with a specified level of accuracy.

2. Methods according to claim 1, by which the plurality of temporarily variable status descriptions describe a dynamic process, that can be described by an economic key figure.

3. Assembly for computer-assisted mapping of a plurality of temporarily variable status descriptions that each describe a temporarily variable state of a dynamic system at an associated point in time in a state space which dynamic system maps an input variable to an associated output variable, with the following components
a) with a first mapping unit that is created in such a way that a first status description in a first state space can be mapped by a first mapping onto a second status description in a second state space,
b) and the first mapping unit is created in such a way that with the first mapping the second status description of a temporarily earlier state can be taken into account,
c) with a second mapping unit that is created in such a way that the second status description can be mapped by a second mapping onto a third status description in the first state space, identified by the fact that
d) the assembly features a third mapping unit that is created in such a way that the first status description can be mapped by a third mapping to a fourth status description in the second state space,
e) and the third mapping unit is created in such a way that with the third mapping the fourth status description of a temporarily later state can be taken into account,
f) and the assembly features a fourth mapping unit that is created in such a way that the fourth status description can be mapped by a fourth mapping onto the third status description, whereby the mapping units are created in such a way that the mappings of the first status description onto the third status description describes the mapping of the input variable onto the associated output variable with a specified level of accuracy.

4. Assembly according to claim 3, with which at least a part of the mapping units are artificial neurons.

5. Assembly according to claim 3 or 4, with which the temporarily variable status description is a vector of a specifiable dimension.

6. Assembly according to claim 1 to 5, with a measurement arrangement to record physical signals with which the dynamic system is described.

7. Assembly according to claim 6, used to determine a dynamic of an electro cardiograph.

8. Assembly according to one of the claims 3 to 7, used for speech processing whereby the input variable is a first item of speech information of a word to be spoken and/or a syllable to be spoken and the output variable is a second item of speech information of the word to be spoken and/or the syllable to be spoken.

9. Assembly according to claim 8, with which the first item of speech information comprises a classification of the word to be spoken and/or the syllable to be spoken and/or a break information of the word to be spoken and/or the syllable to be spoken and/or the second item of speech information comprises accentuation information of the word to be spoken and/or the syllable to be spoken.

10. Assembly according to claim 9, with which the first item of speech information comprises phonetic and/or structural information of the word to be spoken and/or the syllable to be spoken and/or the second item of speech information comprises frequency information of the word to be spoken and/or the syllable to be spoken.

11. Methods for training an assembly for computer-assisted mapping of a plurality of temporarily variable status descriptions each of which describes a temporarily variable state of a dynamic system at unassociated point in time in a state space, which dynamic system maps as input variable onto an associated output variable, which assembly features the following components
a) with a first mapping unit that is created in such as way that a first status description in a first state space can be mapped by a first mapping onto a second status description in a second state space,
b) and the first mapping unit is created in such a way that with the first mapping the second status description a temporarily earlier state can be taken into account,
c) with a second mapping unit that is created in such a way that the second status description can be mapped by a second mapping onto a third status description in the first state space,
d) with a third mapping unit that is created in such a way that the first status description can be mapped by a third mapping onto a fourth status description in the second state space,
e) and the third mapping unit is created in such a way that with the third mapping the fourth status description of a temporarily later state can be taken into account,
f) with a fourth mapping unit that is created in such a way that the fourth status description can be mapped by a fourth mapping onto the third status description,
whereby for the training using at least one specified training data pair which is formed from the input variable and the associated output variable, the mapping units is created in such a way that the mapping of the first status description to the third status description describes the mappings of the input variable onto the associated output variable with a specified level of accuracy.
